(19) United States
(12) Patent Application Publication
(10) Pub. No.: US 2012/0197586 A1
(43) Pub. Date: Aug. 2, 2012

(54) I/O Module with Multi-Dimensional Cold Junction Compensation

(76) Inventors: Rain Jilin Zhang, Singapore (SG); Ting Wu, Singapore (SG); Forrest Xu Caigang, Singapore (SG)

(21) Appl. No.: 13/363,496

(22) Filed: Feb. 1, 2012

(30) Foreign Application Priority Data
Feb. 1, 2011 (SG) 201100756-4

(51) Int. Cl. G01K 7/01; G06F 15/00

(52) U.S. Cl. 702/133; 374/178; 374/E07.035

(57) ABSTRACT

An I/O circuit for measuring temperatures within an industrial control system uses a stored empirical model together with input from at least one reference temperature sensor to determine inter-terminal temperature differences for more accurate cold junction compensation.

### CROSS REFERENCE TO RELATED APPLICATION

This application claims priority to Singapore Patent Application No. 201100756-4 filed on Feb. 1, 2011, the disclosure of which is expressly incorporated herein.

### BACKGROUND OF THE INVENTION

The present invention relates to circuits for industrial controllers that may communicate with temperature sensors and in particular to an input/output (I/O) module providing improved cold junction compensation for thermocouples.

Industrial control systems are special purpose computer systems used in monitoring and controlling industrial processes. Under the direction of a stored control program, a programmable logic controller, being part of the industrial control system, reads inputs from one or more I/O modules and writes outputs to one or more I/O modules. The inputs are derived from signals obtained from sensors associated with the industrial process and the output signals produce signals to actuators and the like in the industrial process. The inputs and outputs may be binary, that is on or off or analog, providing a value with a continuous range or more complex I/O devices like motor controllers and the like.

The I/O module, as the name implies, may be modular and is usually user selected from a variety of different I/O module types dependent on the user's requirements. For example, different I/O modules may provide input or output signals, digital or analog formats, current loop signals and inputs for thermocouples and other sensors. In keeping with this modularity, the I/O module may mount to an industry standard bracket or other mounting device by way of a user selected mounting component.

The I/O module may provide a plurality of connectors (such as screw terminals) arrayed in a terminal block to simplify connection of the I/O module to sensors and actuators. The terminal block for an I/O module used to measure temperature may provide for one or more connection points for temperature measuring devices such as thermocouples, thermistors, and resistive thermal devices (RTDs).

As is understood in the art, thermocouples provide a voltage that is proportional to a difference in temperature between two junctions of dissimilar metals per the Seebeck effect. In order to determine a temperature at one junction (the actual location of the thermocouple or “hot junction”), the second junction where the thermocouple leads are connected (or “cold junction”) may be held at a standard and known temperature (such as when the cold junction is maintained at 32 degrees Fahrenheit in a laboratory). For practical devices, however, this cold junction is not held at a particular temperature but rather the cold junction temperature is measured and used to provide for “cold junction compensation.” The temperature at the thermocouple is determined by combining the absolute temperature of the terminal where the thermocouple is connected (i.e. cold junction temperature) with the relative temperature measurement of the thermocouple. Thus, a thermocouple requires a temperature measuring device which measures an absolute cold junction temperature.

Cold junction temperatures may be determined by temperature measuring devices (also known as cold junction compensators or CJCs). For example, a thermistor or RTD is attached to terminals near the thermocouples to provide a measurement of the temperature in the proximity of those terminals. This cold junction temperature measurement is used for the cold junction compensation of the nearby thermocouple by the I/O module through a cold junction compensation computation typically performed by a processor internal to the I/O module. This compensation process may use a function stored in a lookup table or expressed as a polynomial equation.

### SUMMARY OF THE INVENTION

The present inventors have recognized that a significant source of error in thermocouple measurements by I/O modules is minor temperature variations among the terminals of the terminal block. This error is corrected in the present invention by an empirical model providing temperature differences as a function of ambient temperature. One or more actual terminal measurements are used to adjust them all appropriately. Underlying at least one embodiment of the invention is a recognition that empirically derived temperature differences tend to be constant in a variety of installations of the I/O modules.

Specifically, the present invention provides an I/O circuit for use with an industrial control system. The I/O circuit provides a housing supporting a terminal block having a plurality of terminals arranged in rows and columns to provide terminals displaced from each other in at least two perpendicular directions, the terminals releasably receiving thermocouple leads to obtain a temperature at a temperature measurement location. A processor executes a stored program to read at least one cold junction compensation temperature from at least one terminal and to determine effective cold junction compensation temperatures at other terminals based on a stored empirically derived model.

It is thus a feature of a least one embodiment of the invention to provide improved accuracy of cold junction compensation by providing more accurate cold junction compensation values for up to every terminal of the terminal block with a reduced number of cold junction temperature sensors.

The processor may further execute the stored program to receive at least one temperature signal from a thermocouple at one other terminal and to apply a cold junction compensation correction to the temperature signal based on the determined effective cold junction compensation temperatures at the other terminal and to output the corrected temperature signal.

It is thus a feature of a least one embodiment of the invention to provide a system for improving the accuracy of low-cost thermocouple sensors.

The processor may receive at least two cold junction compensation temperatures from at least two terminals separated along a direction and further execute the stored program to interpolate effective cold junction compensation temperatures at other terminals and wherein the stored, empirically derived model is applied to both the two terminals and the interpolated cold junction compensation temperatures to determine effective cold junction compensation temperatures at other terminals.

It is thus a feature of a least one embodiment of the invention to minimize the necessary extrapolation of the empirically derived model through interpolation when a least two cold junction temperature sensors are available.

The stored empirically derived model may be in the form of a lookup table providing different temperature differences between first and second terminals as a function of ambient temperature at the first terminal.

It is thus a feature of a least one embodiment of the invention to provide a modeling system that can handle arbitrarily complex functions.

The processor may further execute the stored program to accept input location data from a user identifying terminals having cold junction compensation devices attached thereto and wherein the stored program uses the input location data to identify terminals providing cold junction compensation temperatures.

It is thus a feature of a least one embodiment of the invention to permit flexible use of cold junction compensation temperature devices measuring cold junction compensation temperatures.

The invention may provide input circuitry between the processor and the terminals adapted to receive a temperature transducer from a group consisting of a resistance temperature detector (RTD), thermistor, a thermocouple, and a solid-state temperature sensor.

It is thus a feature of a least one embodiment of the invention to provide an I/O module suitable for a variety of different temperature sensors.

The I/O circuit housing may include a mounting slot configured for a DIN mounting rail controlling orientation of the I/O circuit housing.

It is thus a feature of a least one embodiment of the invention to enforce an orientation of the housing that may improve the accuracy of the empirical model.

The I/O circuit may have a plurality of terminals arranged in rows and columns and heights to provide terminals displaced from each other in at least three perpendicular directions.

It is thus a feature of a least one embodiment of the invention to provide up to three dimensions of temperature correction.

The housing may hold heat-producing electronic circuitry in a fixed location with respect to the terminal block.

It is thus a feature of a least one embodiment of the invention to compensate for temperature gradients produced by the I/O module itself.

The described aspects and objects of the present invention will be better appreciated and understood when considered in conjunction with the following description and the accompanying drawings. It should be understood, however, that the following description while indicating preferred embodiments of the present invention is given by way of illustration and not of limitation. Particular objects and advantages may apply to only some embodiments falling within the claims and thus do not define the scope of the invention. Many changes and modifications may be made within the scope of the present invention without departing from the spirit thereof, and the invention includes all such modifications.

### BRIEF DESCRIPTION OF THE DRAWINGS

FIG. 1 is a block diagram of an I/O module showing a thermocouple and two cold junction compensation devices attached to a terminal block of the I/O module for temperature measurement;

FIG. 2 is a perspective view of an I/O module and its terminal block showing the terminals arranged in rows of different heights;

FIG. 3 is a top plan view of the terminal block of FIG. 2 showing the progression of temperature determinations that may be used in the present invention;

FIG. 4 is a flow chart of a program executed by the present invention within the I/O module or elsewhere;

FIG. 5 is a fragmentary representation of an empirical temperature difference model stored as a lookup table.

### DETAILED DESCRIPTION OF THE PREFERRED EMBODIMENT

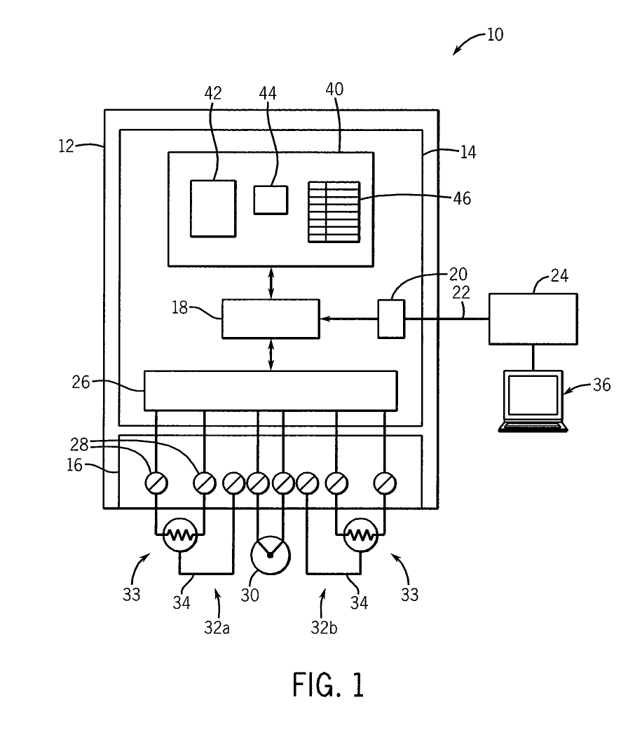

Referring now to FIG. 1, an I/O module 10 may provide for a housing 12 supporting processing electronics 14 and a terminal block 16 in a unitary arrangement. The processing electronics 14 may include a processor 18 such as a microprocessor communicating with an interface 20 connecting over an industrial control network 22 with the remainder of an industrial control system 24 for intercommunication between the I/O module 10 and the industrial control system 24.

The processor 18 may also communicate with I/O interface circuitry 26 that may communicate in turn with multiple screw type terminals 28 on a terminal block 16. The interface circuitry 26 may, for example, implement necessary correction factors and compensations for different types of thermocouples (the Seebeck coefficient) attached to terminals 28 as well as provide for amplification and filtering of the temperature signals. The interface circuitry 26 may include further an analog to digital converter to provide digital values of these received signals to the processor 18.

The screw terminals 28 may be of conventional design and permit releasable attachment to temperature sensors 30 such as thermocouples, resistance temperature detectors (RTD), thermistors, and solid-state temperature sensors used for sensing temperatures as part of an industrial control process. In addition, the screw terminals 28 may attach to cold junction compensation (CJC) temperature sensors 33, typically highly accurate resistive temperature devices. The CJC sensors 33 may measure the temperature at the locations of terminals 28 to which they are connected, or more typically may measure the temperature at a different location 32a or 32b to which they communicate by means of a temperature conductive pigtail 34. These locations 32a or 32b may be entered to the processor 18 by a terminal 36, for example, communicating with the industrial control system 24 (and thus to the processor 18) over the network 22.

The processor 18 may also communicate with a memory 40 holding stored firmware 42 of a type known in the art for operation of the I/O module 10. In addition, the memory 40 may hold a program 44 of the present invention (as will be described below) together with a stored empirical model 46 as will also be described.

The I/O module 10 may further include connections for power and the like not shown for clarity.

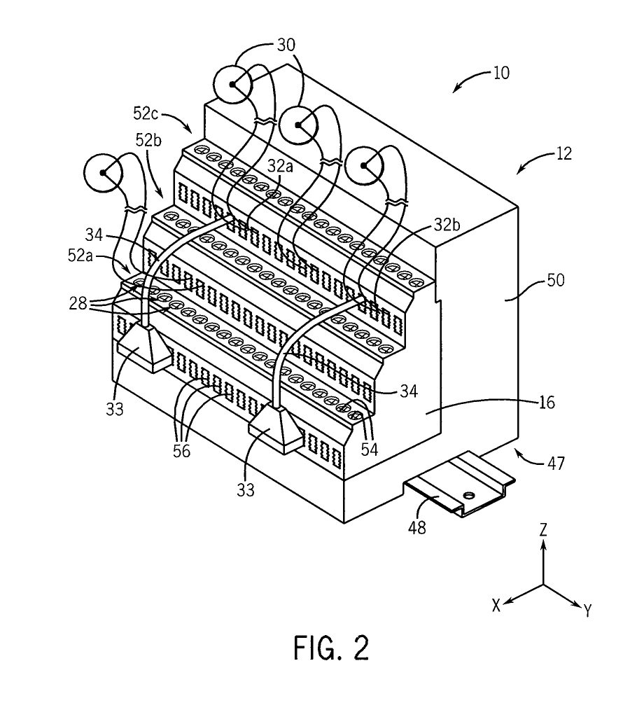

Referring now to FIG. 2, the housing 12 may generally provide a planar base 47 that may be mounted by means of a DIN rail 48 or the like so that the base 47 abuts a vertical planar surface of a similar cabinet structure (not shown). An upper portion of the housing 12 (as the I/O module 10 is so mounted) may provide an enclosure 50 holding the processing electronics 14 against environmental exposure. The enclosure 50 will normally be positioned adjacent to and above the terminal block 16 as the housing 12 is mounted. Heat generated by the processing electronics 14 will generally be conducted upward but some heat will be conducted toward the terminal block 16 through the structure of the housing 12.

The terminal block 16 may arrange the screw terminals 28 in multiple horizontal rows 52a-52c where row 52c is closest to the enclosure 50 and furthest removed from the base 47 and row 52a is furthest from the enclosure 50 and closest to the base 47. The rows 52a-52c are thus laid out in a stair-step arrangement where each row 52a-52c has a different height providing improved access to the screw terminals. Each row 52a-52c may provide for plurality of front facing screw access apertures 54 and downward facing conductor entry apertures 56. The screw terminals 28 are generally arranged in columns across the rows.

As shown, two CJC sensors 33 may be mounted at opposite ends of row 52a with their pigtails 34 connected at opposite ends of row 52c. Multiple thermocouples 30 may be distributed among rows 52c and 52b. Generally this arrangement of CJC sensors 33 and thermocouples 30 is arbitrary and provided for example only.

Referring now to FIGS. 1, 3 and 4, the processor 18 may execute the stored program 44 to accept from a user the locations 32a and 32b on the terminal block 16 at which the CJC sensors 33 measure temperatures, e.g. a row and column of a terminal 28, (in this case in row 52c) and the locations of the electrical connections to the CJC sensors 33 (in this case in row 52a). This is indicated by process block 60.

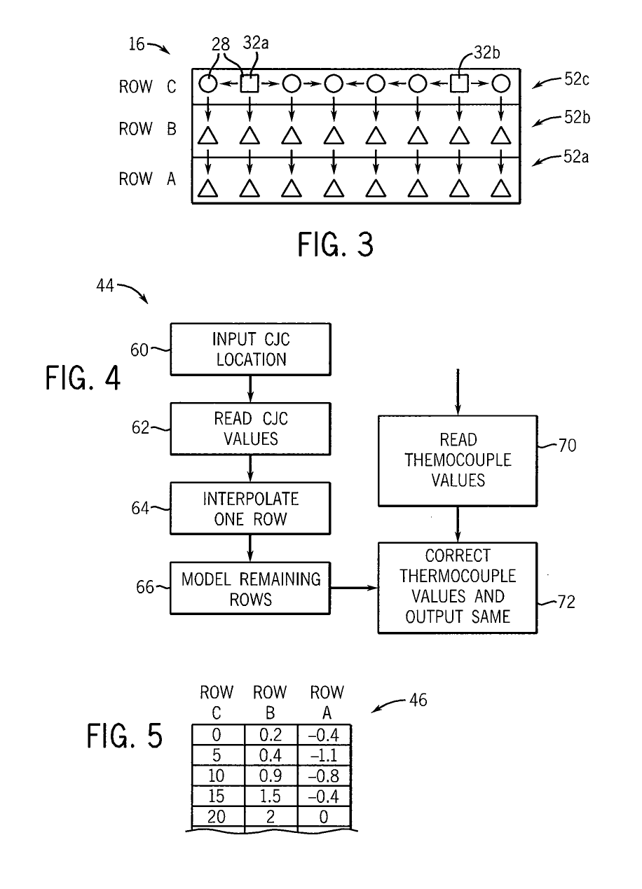

At succeeding process block 62, the temperatures provided by those CJC sensors 33 are obtained by reading the connections at row 52a through interface circuitry 26. These temperatures and their locations are indicated by the squares in FIG. 3.

In a first embodiment, when there are at least two CJC sensors 33, the temperatures at locations 32a and 32b are interpolated and extrapolated along row 52, for example, by a linear or polynomial spline to produce the temperatures as shown by the circles in FIG. 3. This process is shown by process block 64.

In a succeeding process block 66, cold junction compensation temperatures for the remaining terminals of rows 52b and 52a may then be obtained by means of the empirically derived model 46 that captures an expected heating of and heat dissipation by the terminal block 16 in a typical environment at a variety of ambient temperatures. This modeling is possible because of the recognition that there is some consistency in the relative temperature differences among terminals 28 in a variety of different installations.

Generally this empirically derived model 46 may be produced by testing a variety of actual terminal blocks 16 in operating I/O modules 10 at a variety of different ambient temperatures and in different applications. Multiple temperature measurements may then be averaged or otherwise statistically analyzed to produce model temperature difference values indicating temperature differences between terminals 28 as a function of ambient temperature.

Referring now to FIG. 5, a simple version of this model 46 may provide a lookup table 68 having three columns representing each of the rows 52a-52c denoted as rows A-B respectively, and different rows representing different ambient temperatures. In the present example, interpolated temperatures for each terminal 28 of Row C, obtained as described above with respect to process block 64, may be applied to the first column of the lookup table 68 to determine temperature differences for the other terminals 28 in the same column. Thus, for example, if the environmental temperature measured at Row C is five degrees Celsius, a 0.4 temperature difference is indicated to exist at Row B in that column (providing a cold junction compensation temperature at that terminal of 5.4 degrees Celsius) and a temperature difference of −1.1 degree Celsius will be expected at Row A for that column making its cold junction compensation temperature 3.9 degrees Celsius. This process can be done for each column to produce the model temperature values indicated by triangles in FIG. 3. It will be understood that cold junction compensation temperatures for any row may be used as a starting point.

Referring again to FIG. 4, the processor 18 may then read thermocouple temperature values as indicated by process block 70 determining the terminal numbers to which those thermocouples are attached by the normal addressing scheme of the interface circuitry 26 shown in FIG. 2. At process block 72, a standard cold junction compensation computation may then be performed using the temperatures derived per FIG. 3 as applied to the appropriate terminals to which the thermocouples 30 are attached. Corrected temperature values may then be output typically to the industrial control system 24 of FIG. 2.

It will be appreciated that as few as a single CJC sensor 33 may be used through the use of a model that includes both column and row temperature differences. The model 46 may not be implemented in a lookup table but may be implemented in terms of an equation, for example polynomial or the like, or by other well-known storage techniques. Cold junction compensation of process block 72 may be switched on and off, for example, by user command to the terminal 36 when this interface circuitry 26 is used with non-thermocouple sensors.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What we claim is:

1. An I/O circuit for use with an industrial control system comprising:
a housing providing a terminal block having a plurality of terminals arranged in rows and columns to provide terminals displaced from each other in at least two perpendicular directions, the terminals releasably receiving thermocouple leads to obtain a temperature at a temperature measurement location;
a processor executing a stored program to read at least one cold junction compensation temperature from at least one terminal and to determine effective cold junction compensation temperatures at other terminals based on a stored empirically derived model.

2. The I/O circuit of claim 1 wherein the processor further executes the stored program to receive at least one temperature signal from a thermocouple at one other terminal and to apply a cold junction compensation correction to the temperature signal based on the determined effective cold junction compensation temperatures at the other terminal and to output a corrected temperature signal.

3. The I/O circuit of claim 2 wherein the processor further receives at least two cold junction compensation temperatures from at least two terminals separated along a direction and further executes the stored program to interpolate effective cold junction compensation temperatures at other terminals and wherein the stored, empirically derived model is applied to both the two terminals and the interpolated cold junction compensation temperatures to determine effective cold junction compensation temperatures at other terminals.

4. The I/O circuit of claim 1 wherein the stored empirically derived model is in the form of a lookup table providing different temperature differences between first and second terminals as a function of ambient temperature at the first terminal.

5. The I/O circuit of claim 1 wherein the processor further executes the stored program to accept input location data from a user identifying terminals having cold junction temperature sensors attached thereto and wherein the stored program uses the input location data to identify terminals providing cold junction compensation temperatures.

6. The I/O circuit of claim 1 further including input circuitry between the processor and the terminals adapted to receive a temperature transducer from a group consisting of a resistance temperature detector (RTD), thermistor, a thermocouple, and a solid-state temperature sensor.

7. The I/O circuit of claim 1 wherein the I/O circuit housing includes a mounting slot configured for a DIN mounting rail controlling orientation of the I/O circuit housing.

8. The I/O circuit of claim 1 wherein the terminal block has a plurality of terminals arranged in rows and columns and heights to provide terminals displaced from each other in at least three perpendicular directions.

9. The I/O circuit of claim 1 wherein the housing holds heat producing electronic circuitry in a fixed location with respect to the terminal block.

10. A method of measuring temperatures in an I/O circuit in a terminal block having a plurality of terminals arranged in rows and columns to provide terminals displaced from each other in at least two perpendicular directions, the terminals releasably receiving thermocouple leads to obtain a temperature at a temperature measurement location, the method comprising the steps of:
(a) reading at least one cold junction compensation temperature from at least one terminal; and
(b) determining effective cold junction compensation temperatures at other terminals based on a stored empirically derived model.

11. The method of claim 10 further including the steps of receiving at least one temperature signal from a thermocouple at one other terminal and applying a cold junction compensation correction to the temperature signal based on the determined effective cold junction compensation temperatures at the other terminals and to output the corrected temperature signal.

12. The method of claim 10 wherein at least two cold junction compensation temperatures are receive from at least two terminals separated along a direction and further including the step of interpolating effective cold junction compensation temperatures at other terminals and wherein the stored, empirically derived model is applied to both the two terminals and the interpolated cold junction compensation temperatures to determine effective cold junction compensation temperatures at other terminals

13. The method of claim 10 wherein the stored empirically derived model is in the form of a lookup table providing different temperature differences between first and second terminals as a function of ambient temperature at the first terminal.

14. The method of claim 10 including the step of accepting input location data from a user identifying terminals having thermocouples attached thereto and wherein the stored program uses the input location data to identify a cold junction compensation temperature for the thermocouple

15. An I/O circuit for use with an industrial control system comprising:
an I/O circuit housing supporting a terminal block having a plurality of terminals arranged in rows and columns to provide terminals displaced from each other in at least two perpendicular directions, the terminals releasably receiving thermocouple leads to obtain a temperature at a temperature measurement location;
a processor executing a stored program to read at least two cold junction compensation temperatures from at least two terminals and to determine effective cold junction compensation temperatures at other terminals based on an interpolation between at least two cold junction compensation temperatures and to further read at least one temperature signal from a thermocouple at one other terminal and apply a cold junction compensation correction to the temperature signal based on the determined effective cold junction compensation temperatures at the other terminal and to output the corrected temperature signal.
